(19) United States
(12) Patent Application Publication
(10) Pub. No.: US 2025/0011156 A1
(43) Pub. Date: Jan. 9, 2025

(54) SADDLE FOR HORSE RIDING

(71) Applicant: PRESTIGE ITALIA S.P.A., TRISSINO (IT)

(72) Inventors: Giuliano GALLO, CASTELFRANCO VENETO (IT); Filippo RANCATI, BRESCIA (IT)

(21) Appl. No.: 18/710,945

(22) PCT Filed: Nov. 14, 2022
(86) PCT No.: PCT/EP2022/081807

§ 371 Date: May 16, 2024

(30) Foreign Application Priority Data
Nov. 18, 2021 (IT) 202021000005405

(51) Int. Cl. B68C 1/14

(52) U.S. Cl. CPC B68C 1/14

(57) ABSTRACT

A saddle for horse riding including a supporting frame associated with at least one covering body adapted to define a seat for the rider, the supporting frame having a front region, with the gullet iron, and a rear region, with at least one rear cantle. The having, laterally with respect to the seat, respective flaps, and at least two billets arranged on opposite sides with respect to the seat and are configured to fix the saddle to a girth, wherein each flap is associated, at a surface intended during use to be directed toward the horse, with a sheet-like element, an engagement body being accommodated between each flap and the corresponding sheet-like element and defining seats that are selectively engaged by a respective billet.

### CROSS-REFERENCE TO RELATED APPLICATIONS

This application is a 35 U.S.C. § 371 National Stage patent application of PCT/EP2022/081807, filed on 14 Nov. 2022, which claims the benefit of Italian patent application 202021000005405, filed on 18 Nov. 2021,the disclosures of which are incorporated herein by reference in their entirety.

### TECHNICAL FIELD

The present disclosure relates to a saddle for horse riding.

### BACKGROUND

Saddles for horse riding are normally constituted by a core, saddlebow or supporting frame made of plastic or composite material, wood or tempered steel, the purpose of which is to hold the rider, and which extends from the gullet iron, at the front, to the cantle, at the rear.

The frame and the parts associated with it are covered by a covering, which is modeled so as to constitute the seat.

Typically, in addition to the seat, saddles are provided with cushions and with flaps, which are often provided with a padding the purpose of which is to support the knee of the rider.

In order to free the shoulders of the horse and ensure a greater freedom of movement for the animal, the shape of the front portion of frames (gullet iron) has been modified and widened over time, which by contrast sometimes leads to a greater instability of the saddle on the horse.

The billets, i.e. the straps that fix the saddle to the girth, are usually free to oscillate forward and backward with respect to the horse.

This movement of the billets does not ensure a stable balance of the saddle on the horse. This problem is evident especially in saddles for English riding, and especially in saddles used for dressage.

The solutions adopted to reduce this problem present some drawbacks, however.

A first known solution, in which the billet is stitched to the flap, generally at its lower portion, does limit the oscillating movement, but it presents a slight impediment to the breathing movement of the horse. Furthermore, the mutual attachment is final and therefore the stitching must be carried out following a dedicated stage of testing and adapting the wearability of the saddle on the horse.

In other known solutions, engagement openings are provided, or engagement through loops for the billets are applied directly on the flap. Such solutions are particularly conspicuous from the aesthetic point of view, however.

### SUMMARY

The aim of the present disclosure is to provide a saddle for horse riding that is capable of improving the known art in one or more of the abovementioned aspects.

Within this aim, the disclosure makes available a saddle for horse riding that makes it possible to adjust the position of the billets, rapidly and extremely effectively.

The disclosure also devises a saddle for horse riding that, although it offers the possibility of adjusting the position of the billets, does not have an impact on the appearance of the saddle.

the disclosure further provides a saddle for horse riding that is highly reliable, relatively easy to implement and low-cost.

This aim and these and other advantages which will become more apparent hereinafter are achieved by providing a saddle for horse riding according to the independent claim, optionally provided with one or more of the characteristics of the dependent claims.

### BRIEF DESCRIPTION OF THE DRAWINGS

Further characteristics and advantages of the disclosure will become more apparent from the detailed description that follows of a preferred, but not exclusive, embodiment of the saddle for horse riding according to the disclosure, which is illustrated for the purposes of non-limiting example in the accompanying drawings wherein:

FIG. 1 is an external view of a saddle for horse riding according to the disclosure;

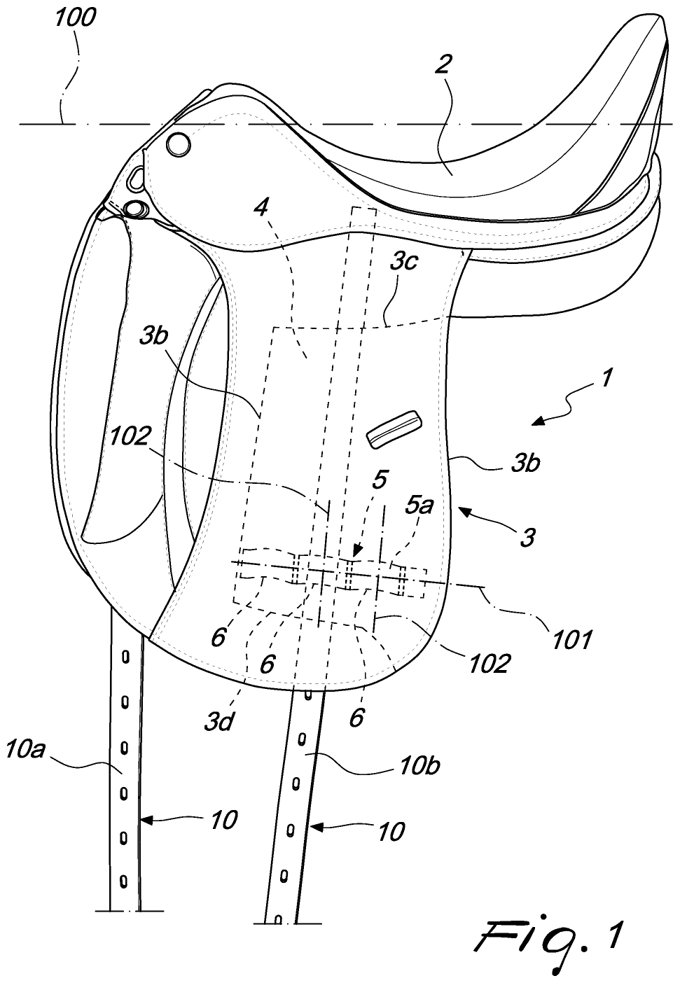

FIG. 2 is an internal view of the left-hand flap of the saddle according to the disclosure; and

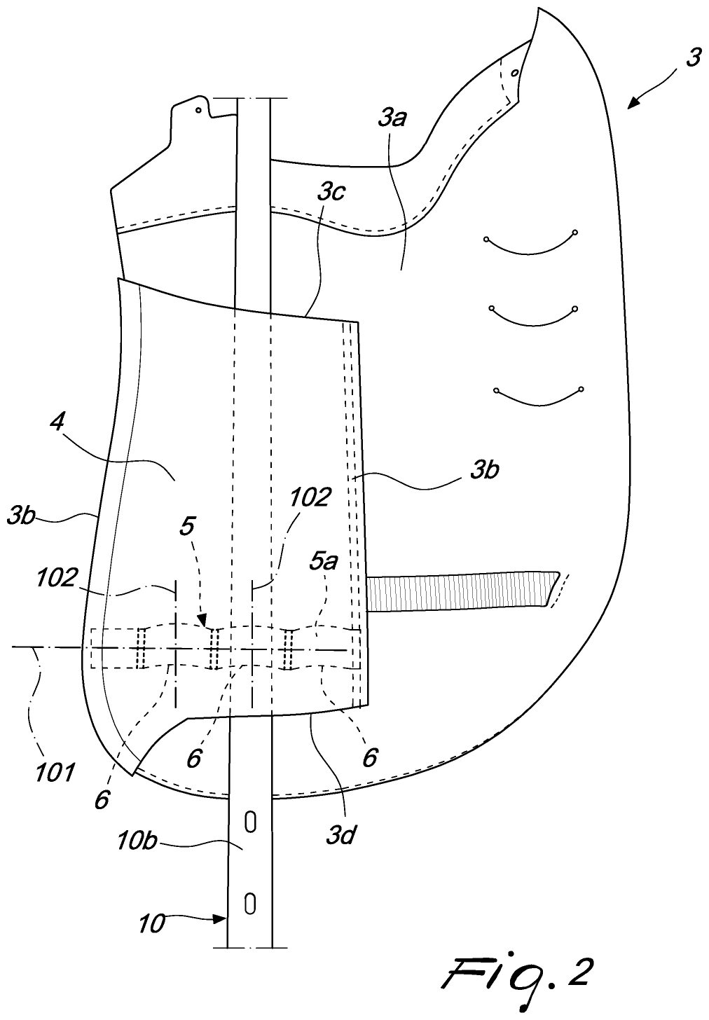

FIG. 3 is a perspective view from below of the portion of saddle between the flap and the sheet-like element.

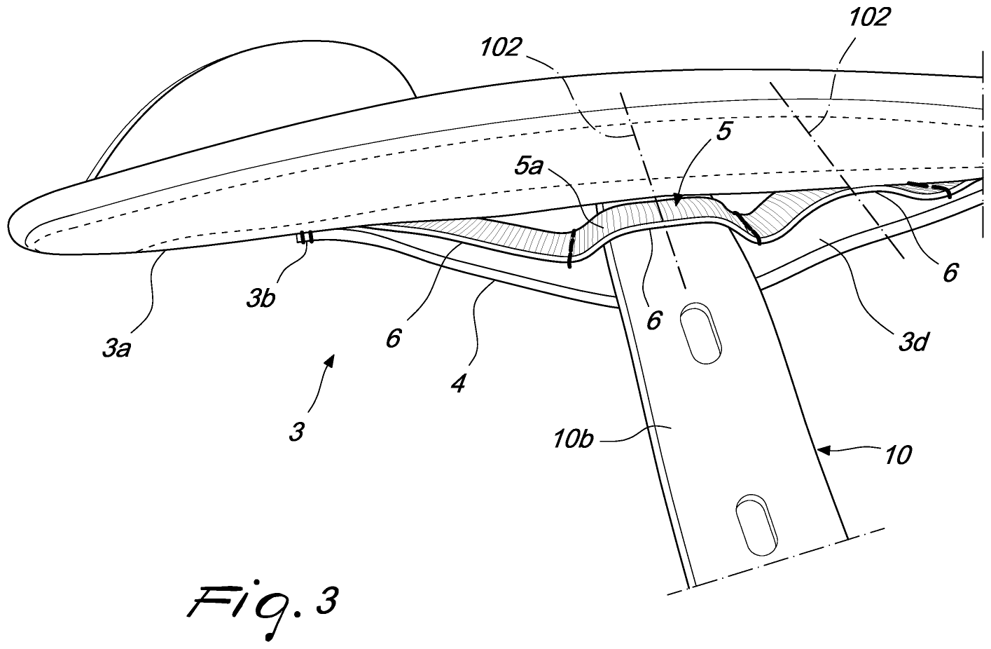

### DETAILED DESCRIPTION OF THE DRAWINGS

With reference to the figures, the saddle for horse riding according to the disclosure, generally designated by the reference numeral 1, comprises a supporting frame associated with at least one covering body which is adapted to define a seat 2 for the rider.

The supporting frame has a front region, which comprises the gullet iron, and a rear region, which comprises at least one rear cantle.

The saddle for horse riding 1 has, laterally with respect to the seat 2, respective flaps 3, and at least two billets 10 arranged on opposite sides with respect to the seat 2, which are configured to fix the saddle 1 to a girth.

According to the present disclosure, each flap 3 is associated, at the surface 3a intended during use to be directed toward the horse, with a sheet-like element 4.

In particular, the sheet-like element 4 is connected, and in particular stitched, at its lateral portions 3b, to the surface 3a of the respective flap 3 that is directed toward the horse, so as to be open at its higher 3c and lower 3d edges.

In this manner, the billets 10 can be arranged between the surface 3a of the flap that is directed toward the horse, and the sheet-like element 4.

Between each flap 3 and the corresponding sheet-like element 4, an engagement body 5 is accommodated which defines a plurality of seats 6 that can be selectively engaged by a respective billet 10.

With reference to the embodiment shown in the figures, there are a front billet 10a and a rear billet 10b at each flap 3.

In particular, the seats 6 can be selectively engaged by a respective rear billet 10b.

Preferably, the engagement body 5 comprises an elongated band 5a which is stably fixed to the sheet-like element 4, advantageously by lines of stitching that are mutually spaced apart so as to form, in cooperation with the sheet-like element 4, the seats 6.

Conveniently, the seats 6 are mutually spaced apart along a direction 101 of extension that is substantially parallel to the axis 100 of longitudinal extension of the saddle 1.

The seats 6 are defined by loops which extend around a respective axis 102 that is substantially vertical during use.

The use of the saddle for horse riding, according to the disclosure, is the following.

Before use, the rear billet 10b is brought between the surface 3a directed toward the inside of the flap 3 and the sheet-like element 4, then its lower end is inserted into one of the seats 6 defined by the engagement body 5.

In practice it has been found that the disclosure fully achieves the intended aim and advantages, by making it possible to prevent the oscillatory movement of the rear billets 10b, by forcing them to pass through the chosen seat 6.

The proposed solution does not have an impact on the appearance of the saddle.

At the same time, the proposed solution ensures that the flap 3 stays better adhered to the horse, and likewise prevents the flap from curling under the leg of the rider, in so doing limiting its freedom of movement.

The disclosure thus conceived is susceptible of numerous modifications and variations, all of which are within the scope of the appended claims. Moreover, all the details may be substituted by other, technically equivalent elements.

In practice the materials employed, provided they are compatible with the specific use, and the contingent dimensions and shapes, may be any according to requirements and to the state of the art.

1.-5. (canceled)

6. A saddle for horse riding comprising: a supporting frame associated with at least one covering body adapted to define a seat for the rider, said supporting frame having a front region, comprising a gullet iron, and a rear region, comprising at least one rear cantle, said saddle for horseback riding having, laterally with respect to said seat, respective flaps, said saddle comprising at least two billets which are arranged on opposite sides with respect to said seat and are configured to fix said saddle to a girth, wherein each flap is associated, at a surface intended during use to be directed toward a horse, with a sheet element, an engagement body being accommodated between each flap and the corresponding sheet element and defining a plurality of seats which are configured to be selectively engaged by a respective billet.

7. The saddle for horse riding according to claim 6, wherein said at least two billets comprise, at each flap, a front billet and a rear billet, said plurality of seats being engageable selectively by a respective rear billet of said front and rear billets.

8. The saddle for horse riding according to claim 6, wherein said engagement body comprises an elongated band which is fixed stably to said sheet element.

9. The saddle for horse riding according to claim 6, wherein said seats are mutually spaced apart along a direction of extension that is substantially parallel to an axis of longitudinal extension of the saddle.

10. The saddle for horse riding according to claim 6, wherein said seats are defined by loops which extend around a respective axis that is substantially vertical during use.
